(19) United States
(12) Patent Application Publication
(10) Pub. No.: US 2013/0339042 A1
(43) Pub. Date: Dec. 19, 2013

(54) SYSTEM AND METHOD FOR PROVIDING A MEDICAL DIAGNOSTIC CONCORDANCE

(71) Applicant: HEALTHHELP, LLC, Houston, TX (US)

(72) Inventors: Dan Gebow, San Anselmo, CA (US); James Min, Los Angeles, CA (US); John Lorance, Nevada City, CA (US)

(21) Appl. No.: 13/916,668

(22) Filed: Jun. 13, 2013

Related U.S. Application Data
(60) Provisional application No. 61/659,172, filed on Jun. 13, 2012.

(51) Int. Cl. G06Q 50/22; G06Q 10/10

(52) U.S. Cl. CPC G06Q 50/22; G06Q 10/10
USPC 705/2

(57) ABSTRACT

Systems and methods for implementing a web-based software that aids physicians in selecting healthcare treatment options through the use of care algorithms are disclosed. The system and method incorporate an interface that displays Quality Assessment References “QARs” within decision trees that are updated based on user feedback, user submitted justifications, user patterns and new medical discoveries. Through the system and method of the invention users are provided with real-time data related to healthcare diagnoses, treatments and tests. Users are also provided with a decision tree that follows existing QARs for diagnoses, treatments and tests. Users are also provided with the ability to override the existing QAR, if justified. When justifications for overriding the existing QAR reach a predetermined threshold level, the QAR is altered. In this way, the QAR is adaptable based upon user utilization and performance.

### CROSS REFERENCE TO U.S. PROVISIONAL PATENT APPLICATION

This application claims the benefit of U.S. Provisional Application No. 61/659,172 filed on Jun. 13, 2012, the entire disclosure of which is hereby incorporated by reference.

### FIELD OF THE INVENTION

The present invention relates to systems and methods for enabling informed healthcare decisions. More specifically, the invention relates to an improved system and method for a computer-implemented decision tree to aid in healthcare screening decisions.

### BACKGROUND OF THE INVENTION

Health care spending continues to rise, but evidence suggests that inconsistencies and quality issues related to healthcare persist. For example, the Agency for Healthcare Research and Quality (AHRQ) reports that, for many of the most prevalent diseases, health spending increases faster than the rate of quality improvement. Furthermore, findings related to geographic variations in treatments and the prevalence of medical errors also show that there has not been an increase in the quality of care commensurate with the increase in healthcare spending. Despite large differences in Medicare spending across geographic regions, the quality of care is not significantly greater in higher-spending areas. It is also estimated that as many as 100,000 Americans die each year due to medical errors.

One reason for geographic variations and inconsistent quality is lack of information regarding what constitutes appropriate diagnosis, testing and treatment for conditions. Many existing quality measures focus on fairly simple protocols. For instance, in its National Healthcare Quality Report, AHRQ uses 41 core quality measures (and 211 total quality measures) to evaluate the treatments for a number of prevalent conditions. For example, the core guidelines for heart disease include whether recommended care is received for a heart attack; whether smokers, while hospitalized, are counseled to quit smoking; and whether obese adults are counseled about exercise. These are relatively straightforward guidelines for healthcare practitioners to implement, but even with straightforward guidelines there is a significant gap in the quality of care received. Similarly, a study assessing quality of care by examining the extent to which standard treatment protocols are adhered to concluded that patients receive only 55 percent of the recommended care.

To have value, information about what diagnoses, treatments or tests are appropriate must be available to and used by clinicians. However, it is estimated that an average of 17 years passes before research-generated knowledge about medical treatments is incorporated into widespread clinical practice. Even if information is available, application of the information remains inconsistent.

Further, when new health care technologies and treatment protocols are developed, insurers must determine whether and how to incorporate them into an insurance plan. Decisions need to be made not only regarding whether to cover the new technology or protocol, but also how it should be reimbursed.

Insurers have several resources available to help with these decisions. Many private insurers subscribe to technology assessment services which evaluate the scientific evidence of emerging health technologies. Other insurers perform their own analyses rather than subscribe to an outside assessment organization. Furthermore, most large insurers that subscribe to an outside assessment organization perform some health technology assessment in-house, as well. Other resources for assessment include federally funded assessment centers, most often housed at various universities.

In addition, private health insurance plan documents typically contain provisions that affect whether specific benefits are determined to be covered by the policy. These types of provisions usually come in three forms. A plan document could contain language specifying that any covered medical services be of “proven benefit” (i.e., not experimental or investigational). A plan document could also contain language stating that covered services must be “medically necessary.” Further, plan documents often contain a list of specific exclusions. For example, most plans specifically exclude cosmetic procedures or non-restorative speech therapy. Although they may be covered at times, some more discretionary or lifestyle-related services such as bariatric surgery may also be excluded, regardless of supporting clinical evidence.

Insurers then make specific coverage determinations based on the information available. Formal policies are developed proactively whenever possible, using evidence-based health technology assessments to determine whether a health service or procedure is of “proven benefit.” These policies are typically applied statically and their application and underlying reasoning is not known to physicians.

One drawback related to typical coverage decisions in practice is that the criteria for making the decisions are not known to physicians. This lack of transparency can lead to inefficiencies, lack of predictability, and frustration in recommending care. Another drawback related to typical coverage decisions is the length of time required to obtain an approval decision. Oftentimes, healthcare practitioners must contact call centers over the telephone to obtain an approval decision.

Beyond coverage decisions, health technology assessments are also used to determine how a medical treatment will be reimbursed. If an insurer decides to cover a particular treatment, the level of reimbursement may depend not only on its cost but also on evidence regarding whether it is proven to be more effective than other existing treatments. A new technology that is more costly, but more effective in the long run, is more likely to be reimbursed at a higher rate than the existing technology.

For instance, total hip replacement prosthesis includes artificial joints made with titanium, ceramic, and other materials. Conventional wisdom is that newer joint replacements made with composite materials will pay for themselves in the long term due to having a longer functional life. However, there are no comparative studies to support that conclusion. As a result, insurers could opt to reimburse the newer joints at the same rate as the older ones or pay the higher price only for younger patients with longer life expectancies. In contrast, local third party administrators could simply reimburse at the higher rate for the “newest” joint replacement, with little review.

Beyond relying solely on an economic assessment of relative long-term costs, insurers could opt to reimburse newer technologies at a higher rate when they are proven to increase safety, be more effective, or reduce recovery times. One example is minimally invasive surgery for heart valve replacements. Instead of performing open-heart surgery with its inherent risks, the surgeon performs the surgery through small incisions in the patient's chest. For suitable candidates, this has been shown to reduce recovery time significantly and the inpatient stay is generally reduced. Health plans often cover such procedures at a higher reimbursement rate.

Furthermore, coverage decisions are generally based on average health conditions over large populations. However, most chronic medical conditions are multivariate or confounded by other diseases (co-morbidities). Therefore, the guidelines issued by insurers tend to be overly simplistic for the sake of clarity and expediency of applying them in the clinic.

As new technology assessments are made, they are often limited by a lack of credible clinical data. Either there are no data at all or the data that are available do not offer enough high-quality evidence comparing the new technology to existing treatments or technologies. New drug trials provide an interesting example of this. Food and Drug Administration (FDA) approval requires that a drug developer show, through controlled clinical trials, that the drug is proven safe and effective.

Health insurers currently utilize health care technology assessments, in both coverage determination and reimbursement decisions. Nevertheless, these assessments are often limited in scope and value. Most of the existing research regarding technology assessment is based on secondary research of clinical analyses that are focused on and rarely go beyond proving that a treatment is safe and effective. Because much of the health care currently provided does not have an underlying evidence base, new methods and systems for informing these decisions are needed.

As the definition of quality of health care is further refined, it will likely lead to higher expectations for measuring and evaluating variation around provider performance and member compliance. That data will also be essential for the implementation of potential benefit incentive strategies as well as reimbursement policies.

Ultimately, the value of this information depends on its ability to positively influence treatment decisions, insurance coverage and reimbursement decisions. Information about diagnoses, treatments and tests can effect reimbursement policies and can influence treatment decisions by encouraging more favorable reimbursement for treatments which are deemed to be more effective (considering both costs and benefits) and discouraging less effective treatments by reimbursing them at less favorable rates.

Thus, there is a need for methods and systems that, when effectively integrated and applied into select areas of health insurance, can help refocus the health care delivery system on the value of care received and facilitate a shift toward more evidence-based medicine. In doing so, it has the potential to increase the quality and value of care as well as reduce the variation in health care treatment and spending. There is also a need for faster decision making related to coverage, better transparency related to the decision making progress, and a higher degree of accessibility and predictability related to coverage decisions.

### SUMMARY OF THE INVENTION

The invention contemplates a web-based software system and method that aids physician in selecting healthcare treatment options through the use of care algorithms. The system and method incorporate an interface that displays diagnoses or treatment options through a Quality Assessment Reference “QAR” in a decision tree that is updated based on user feedback, user submitted justifications, user patterns and new medical discoveries.

The method and system provide users with information that has previously been unavailable to them. For example, users are provided with statistical information regarding the frequency with which a diagnosis, treatment or test is chosen, the appropriateness of a diagnosis, treatment or test, or the cost of a diagnosis, treatment or test. One of the advantages of the invention is that it compresses a great deal of information into a single, easily accessible repository, which eliminates efficiency concerns and allows the application of more differentiated and personalized rule sets.

Importantly, through the system and method of the invention, users have the ability to override the decision tree after providing an acceptable justification for deviating from the established QAR. In this way, a physician is not limited to the established QAR, but has flexibility to select the diagnosis, treatment test he/she sees fit, if justified. In one embodiment of the invention, the decision tree is used to make health insurance coverage determinations. Through the “override” feature of the system and method of the invention, the physician can impact whether deviations from the established QAR are covered by health insurance.

Furthermore, through the system and method of the invention, the QAR is adaptable through the override process. After a particular justification for overriding the established QAR reaches a predetermined threshold, the QAR is automatically updated so that it reflects the diagnosis or treatment selected through the override.

The threshold can vary based on the diagnosis, treatment or test at issue. Determination of thresholds can be ascertained by any number of methods well known to those of skill in the art. The threshold may be a selected percentage value or may be determined by statistical methods such as regression analysis. For example, simple linear regression expressed through a basic equation, Y=mX+b, may be used. Here X, the “independent variable,” may be a characteristic such as a patient's age. Y, in this example, may be the threshold value variable. Additionally, b is the value of Y when X is a minimum value and m is the value characterizing the relationship between the two variables. This is merely one of many possible techniques that may be used to determine the threshold of the invention.

In this way, the number of diagnoses and treatment options provided by the QAR may be expanded or contracted. Furthermore, in this way, the QAR is continuously adapted to reflect the most appropriate diagnoses or treatments.

These and other features and advantages will be apparent from the following brief description of the drawings, detailed description, and appended claims and drawings.

### BRIEF DESCRIPTION OF THE DRAWINGS

Embodiments of the invention will now be described, by way of example, with reference to the accompanying drawings, wherein:

FIG. 1 illustrates a chart of the type used in one embodiment of the invention to indicate percent utilization as function of quality assessment.

FIG. 2 illustrates the interface display of one embodiment of the invention wherein a user is provided the option of “overriding” the existing QAR.

FIG. 3 illustrates the interface display of one embodiment of the invention wherein a justification for an override is requested.

FIG. 4 illustrates the interface display of one embodiment of the invention wherein statistical information related to the diagnosis or treatment is provided.

FIG. 5 is a flowchart describing an embodiment of the invention wherein the QAR is adapted based upon overrides.

### DETAILED DESCRIPTION OF THE DRAWINGS

The following description provides details with reference to the accompanying drawings. It should be understood that the invention may be embodied in many different forms and should not be construed as limited to the embodiments set forth herein.

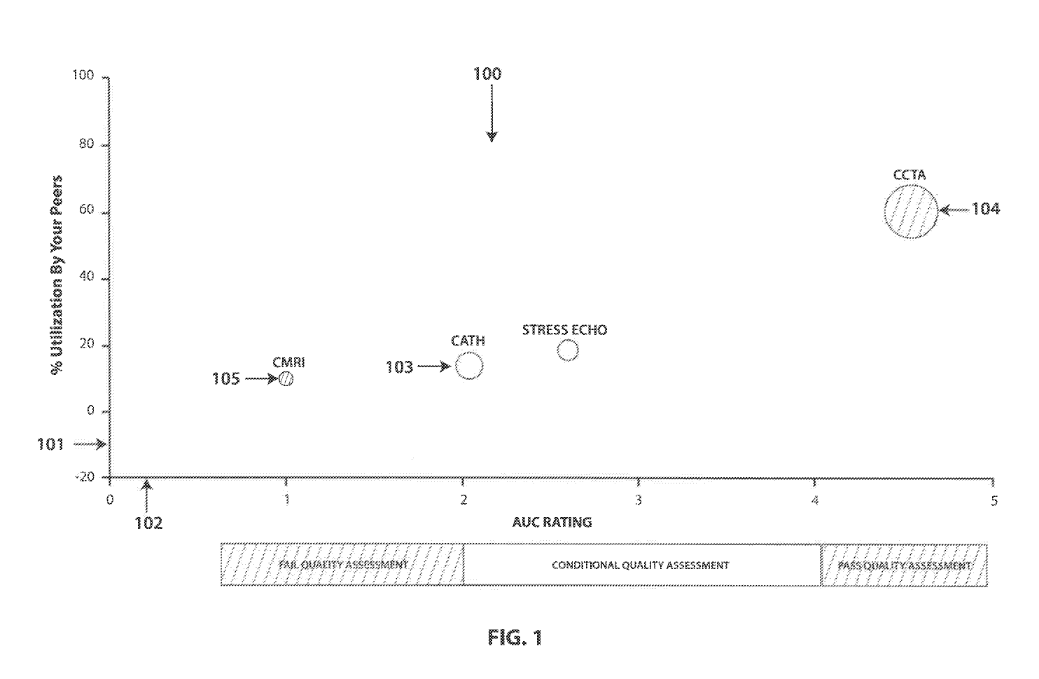

FIG. 1 shows the graphical user interface display 100 as may be shown in one embodiment of the invention. In this embodiment, a chart is provided showing how a user's selection in the decision tree compares with the selections of the user's peers. In this embodiment, the percent utilization by the user's peers is shown on the y-axis 101. Along the x-axis 102, a quality assessment through the appropriate use criteria rating is provided. “Bubbles” 103 are placed within the chart so as to reflect the percent the respective diagnosis or treatment is used by the user's peers, to show how often the diagnosis or treatment is used, and to indicate the appropriateness of the diagnosis or treatment. For example, in this embodiment Cardiac Computed Tomography Angiography (CCTA) is indicated as a test option 104. In this instance the “bubble” for CCTA is relatively large in comparison to other “bubbles” on the chart. This indicates a relatively higher cost for this test. Furthermore, the percent utilization of this test by the user's peers is shown to be approximately 60%. Additionally, the appropriateness of this test is shown to be approximately “4.5,” which is indicated to be “Pass Quality Assessment.” On the other hand, Cardiac Magnetic Resonance Imaging (CMRI) is also indicated as a testing option 105. The “bubble” for CMRI is relatively small in comparison to other “bubbles” on the chart. This indicates a relatively lower cost for this test. Furthermore, the percent utilization of this test by the user's peers is shown to be approximately 10%. Additionally, the appropriateness of this test is shown to be approximately “1,” which is indicated to be “Fail Quality Assessment.” Through the display of FIG. 1, in this embodiment of the invention the user is provided with real-time data reflecting the appropriateness of a diagnosis or treatment. In this way, inconsistencies related to healthcare treatment can be reduced because users will be informed as to how their diagnosis and/or treatment decisions compare to those of their peers. The information in FIG. 1 can also be presented in alternative forms, such as a table. An example of a table of one embodiment of the invention is shown below.

TABLE 1

| Procedure | | | Radiation |
|---|---|---|---|
| Name | Ruling | Score | Dose |
| CT Angio | Conditional Quality Assessment (requires | 3 | 2 to 15 |
| HRT w/3D | justification) | | |
| Image | | | |
| CT HRT | Conditional Quality Assessment (requires | 3 | 2 to 15 |
| w/3D Image | justification) | | |
| Congen | | | |
| CT HRT | Conditional Quality Assessment (requires | 3 | 9 |
| w/3D Image | justification) | | |
| HT Muscle | Conditional Quality Assessment (requires | 3 | 9.3 to 60 |
| Image Spect | justification) | | |
| Mult | | | |
| Heart Image | Conditional Quality Assessment (requires | 3 | 14.1 |
| (PET) | justification) | | |
| Multiple | | | |
| Heart Image | Conditional Quality Assessment (requires | 3 | 14.1 |
| (PET) Single | justification) Conditional Quality | | |
| | Assessment (requires justification) | | |
| Right Heart | Does Not Meet Quality Assessment | 2 | |
| Cath | Standards: Clinical Review | | |
| Venous | Does Not Meet Quality Assessment | 2 | Var |
| Thrombosis | Standards: Clinical Review | | |
| Imaging | | | |

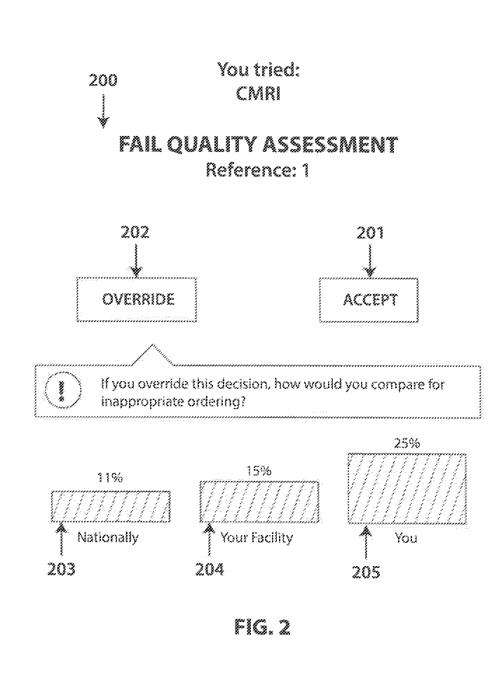

FIG. 2 depicts the graphical user interface of an embodiment of the invention wherein the “override” function is shown 200. In this instance, the user selected the CMRI test. As shown in FIG. 2, CMRI is indicated to “Fail Quality Assessment” with an appropriate use criteria rating of 1. Here, the user is provided with the option to accept the existing QAR 201, which does not recommend the CMRI test. The user is also provided with the option of an override request 202 to alter the existing QAR. The user is further provided with statistical information regarding the frequency of override requests. In this embodiment, the user is provided with the rate an override is requested nationally 203, at the user's facility 204, and by the user 205. In this way, this embodiment of the invention permits users to alter the QAR, if justified, and to incorporate real-time data on the frequency that the established QAR is altered into his/her decision-making process.

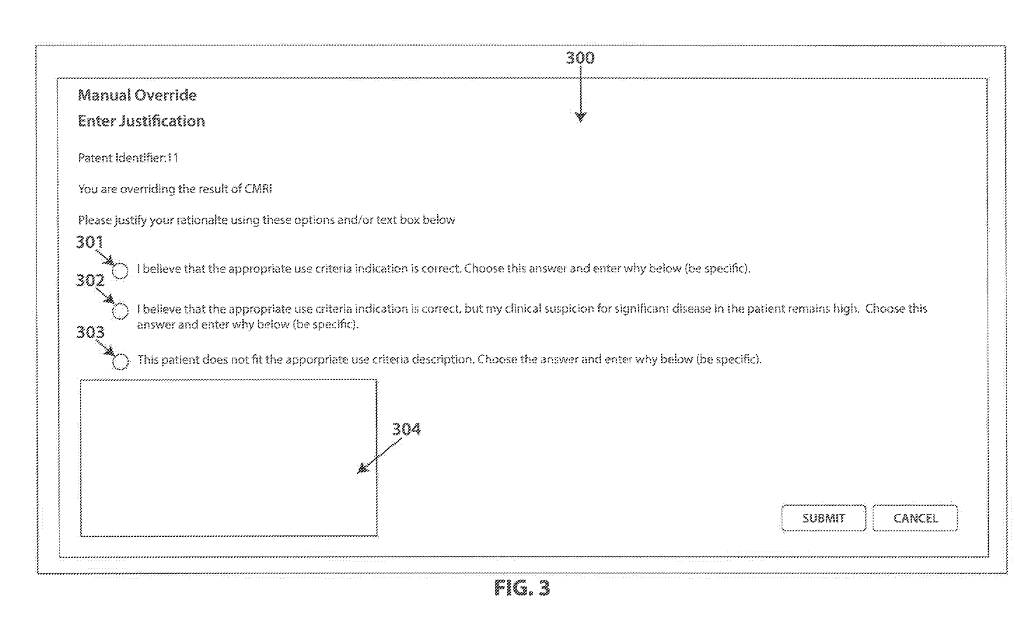

FIG. 3 shows the interface display 300 once the user has selected the option to override the established QAR. In this embodiment, a request is made for the user to justify the override. Here, the user is provided the option to select the rationale for the override. In one option 301, the user may state that the appropriate use criteria indication is incorrect. In another option 302, the user may indicate that the appropriate use criteria indication is correct but that other rationale justifies the override. In a third option 303, the user may indicate that the patient does not fit the appropriate use criteria descriptions. Notwithstanding the justification that is selected, the user is required to provide an explanation 304 of why the override is necessary. In this embodiment, once the explanation provided reaches a predetermined threshold level (e.g., 20% of override requests for the test at issue have the same explanation, such as obesity, high blood pressure, diabetes, pain, or any other condition or symptom) the established pathway is altered to include the test requested by the override when the condition or symptom provided it the explanation is present. In this embodiment, the QAR adapts based upon user overrides so that the diagnoses, treatments or tests that are considered most appropriate by users become part of the established QAR based on user activities. In this way, the invention helps to minimize the delay that frequently exists in establishing diagnoses, treatments and tests as appropriate. In this way, the invention also helps to eliminate inconsistencies in the provision of various diagnostic, treatment and testing options. In one embodiment, the justifications provided may also be collected to establish prewritten justifications in the manual override view.

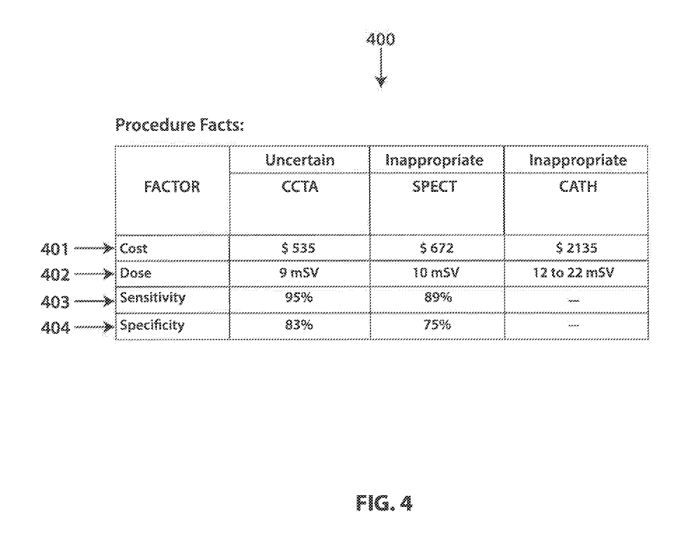

FIG. 4 shows the interface display 400 of an embodiment of the invention. In this embodiment, the user is provided with specific information related to various test options. For example, in this embodiment, average cost 401 is provided for the indicated tests. In addition, recommended dosages 402 are provided. Furthermore, the reliability of the tests is provided through the sensitivity 403 and specificity 404. In this embodiment, therefore, the user is provided with real-time information related to the tests to aid in test selection.

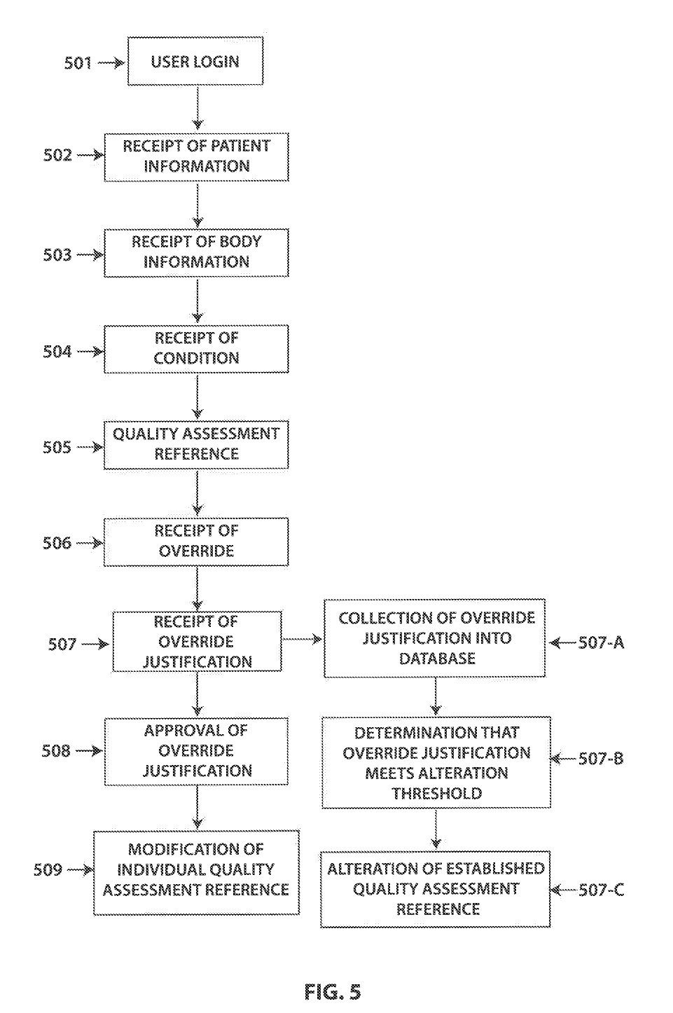

FIG. 5 is a flowchart depicting an embodiment of the invention where an override is requested and approved and the QAR is altered based upon overrides. In step 501 the user provides login information in order to be granted access. In step 502, patient information is received by the system. In step 503, information regarding the body system at issue is received. In step 504, information regarding the patient's condition is received. In step 505, the user is provided with procedure options and the selection of a procedure option is received. In step 506, an override regarding the selected procedure option is received. In step 507, a justification for the requested override is received. In step 507-A, the justification for the requested override is collected into a database. In step 507-B, a determination is made as to whether the justification meets a predetermined threshold. In this example, the predetermined threshold is 20% of all override requests for the given procedure. In this embodiment, the threshold is a trigger for a board of experts to review the data provided and decide if the QAR should be modified. In step 507-C, the established QAR is altered because the justification for the override request exceeds the predetermined threshold. In step 508, the override justification is approved. In step 509, the procedure is authorized.

It is to be understood that the above descriptions and drawings are only for illustrating representative variations of the present invention and are not intended to limit the scope thereof. Any variation and derivation from the above description and drawings are included in the scope of the present invention.

What is claimed is:

1. A method for enhancing healthcare diagnosis, treatment and testing decisions comprising:
a. providing users with a Quality Assessment Reference via a graphical user interface;
b. providing users with a recommended healthcare option in the Quality Assessment Reference;
c. providing users with the ability to request overrides of the recommended healthcare option; and
d. modifying the Quality Assessment Reference based upon user override requests.

2. The method of claim 1 wherein the Quality Assessment Reference is modified after the override requests exceed a predetermined threshold.

3. The method of claim 1 wherein users are provided with real-time statistical information regarding healthcare options.

4. The method of claim 3 wherein the statistical information includes percent utilization by user peers.

5. The method of claim 3 wherein the statistical information includes acceptable use criteria ratings.

6. The method of claim 1 wherein the override is based upon an approved justification provided by the user.

7. The method of claim 1 wherein the override justification is stored in a database.

8. A system for enhancing healthcare diagnosis, treatment and testing decisions comprising:
a. a Quality Assessment Reference displayed via a graphical user interface;
b. a recommended healthcare option displayed in the Quality Assessment Reference;
c. overrides of the recommended healthcare option; and
d. modification of the Quality Assessment Reference based upon the overrides.

9. The system of claim 8 wherein the Quality Assessment Reference is modified after the overrides exceed a predetermined threshold.

10. The system of claim 8 wherein the system further comprises real-time statistical information regarding healthcare options.

11. The system of claim 10 wherein the statistical information includes percent utilization by user peers.

12. The system of claim 10 wherein the statistical information includes acceptable use criteria ratings.

13. The system of claim wherein the overrides are based upon approved justifications.

14. The system of claim 13 wherein the justifications are stored in a database.
